(19) United States
(12) Patent Application Publication
(10) Pub. No.: US 2002/0162938 A1
(43) Pub. Date: Nov. 7, 2002

(54) Facilities connection bucket for pre-facilitation of wafer fabrication equipment

(75) Inventor: Ronald Vern Schauer, Gilroy, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 10/099,900

(22) Filed: Mar. 14, 2002

Related U.S. Application Data
(63) Continuation-in-part of application No. 09/706,435, filed on Nov. 3, 2000.

(51) Int. Cl. F16M 1/00

(52) U.S. Cl. 248/678

(57) ABSTRACT

The present invention provides a standardized facilities box having a mechanism for mounting the box to a support pedestal of a semiconductor fabrication facility (i.e., a pedestal for supporting a semiconductor processing tool, or a support a pedestal of a support grid for a raised floor useable in a semiconductor device fabrication facility). The standardized facilities box includes one or more mechanisms that allow any of a set of add on features to be selectively coupled (i.e., for attachment at predetermined locations without machining) thereto. Other aspects include a facilities box having its own support leg, having a sensor, and/or having a lift/lower mechanism for lifting the facilities box or for lifting items to/from the facilities box.

This application is a continuation-in-part of U.S. patent application Ser. No. 09/706,435, filed Nov. 3, 2000 (AMAT Docket No. 4448/IBSS/DV) and U.S. Ser. No. 09/906,395, filed Jul. 15, 2001 (AMAT Docket No. 4448/P1/CPES/IBSS/DV) the entire disclosures of which are incorporated herein by this reference.

### FIELD OF THE INVENTION

This invention relates generally to a method and apparatus for facilitating installation and use of wafer fabrication equipment in a manufacturing environment.

### BACKGROUND OF THE INVENTION

Buildings employed for production of semiconductor wafers (commonly known as FAB's) are specially designed to accommodate heavy manufacturing equipment and the many fluid, gas, vacuum and electrical lines (i.e., facilities lines) that are necessary for semiconductor manufacturing. Specifically, modern FAB's require a plurality of lower levels beneath the manufacturing equipment. Starting from the top of a FAB and working downward, a typical modern FAB has an ultra high purity air filtration system mounted in the ceiling above the manufacturing equipment. The air filtration system generates a laminar flow of clean air down past the manufacturing equipment and through what is referred to as a raised floor. Conventional raised floors consist of a metal grid or framework held up by a plurality of pedestals. Floor tiles are supported by the metal grid, and are configured so as to support the weight of a plurality of operators who may be working adjacent the manufacturing equipment. The floor tiles may vary considerably in size, shape and thickness.

Raised floor tiles are perforated so that the laminar air flow may continue therethrough to a lower level.

Once in the lower level, the air flows horizontally toward a sidewall and is captured and flowed back to the over head high purity air filtration system for recirculation.

Due to the massive weight of the manufacturing equipment, an interstitial floor used for weight distribution is required between the raised floor and a subfloor. This interstitial floor is commonly comprised of an open grid of reinforced cement, known as a waffle grid floor. Typically each piece of manufacturing equipment is supported by an equipment support pedestal that extends from the waffle grid floor to the raised floor level.

Facilities equipment is maintained in the subfloor level and lines therefrom extend upward through the waffle grid floor and raised floor to the manufacturing equipment. Thus, maintenance personnel are able to work in the lower level, without risk of contaminating the manufacturing level. Unfortunately, personnel in the subfloor area are not without risk of contamination from the manufacturing level, as there is a constant risk that harmful gases and fluids may leak from areas where they connect the manufacturing equipment, where they connect through the raised floor, or where other connections exist.

The Semiconductor Equipment Manufacturing Institute (SEMI) has provided for facilities connection locators between the area beneath the raised floor, and a specific equipment support pedestal. While such locators facilitate preplumbing of facilities lines from the sub-floor to the raised floor, they do not reduce the harmful impact of facilities leaks, nor do they aid location of facilities connections that occur at locations other than equipment support pedestals. Moreover, installation of such facilities connection locators often require cutting and fitting of adjacent floor tiles.

Accordingly, a need exists for methods and apparatuses that will improve safety for FAB personnel, as well as facilitate installation of locating mechanisms.

### SUMMARY OF THE INVENTION

The present invention provides a standardized facilities box comprising a mechanism for mounting the box to a support pedestal of a semiconductor fabrication facility (i.e., a pedestal for supporting a semiconductor processing tool, or a support pedestal of a support grid for a raised floor useable in a semiconductor device fabrication facility). The standardized facilities box further comprises one or more mechanisms that allow any of a set of add on features to be selectively coupled (i.e., attached at predetermined locations without machining) thereto. The set of add-on features comprises one or more of the following:

partitions for separating incompatible facilities;

document storage compartments;

sensors and warning indicators;

automatic lockout mechanisms;

exhaust mechanisms;

tool storage mechanisms,

support legs;

mechanical locating mechanisms for facilities connections (for x and y-axis and in some aspects z-axis locating);

coupling mechanisms adapted to couple a first facilities box to a second facilities box;

openable covers;

emergency floor lighting;

lifting mechanisms adapted to lift and/or lower a facilities box into position;

changeable members to adapt standardized facilities box structures to common floor tile grid systems (e.g., bridge flanges); and

lifting mechanisms adapted to lift and/or lower items to and/or from a facilities box.

In one aspect the invention comprises an assemblable kit comprising a standardized facilities box and one or more of the add-on features listed above.

In another aspect the invention comprises a facilities box having one or more of the add-on features listed above, fixedly coupled thereto (i.e., not selectively coupled thereto). Either of the above aspects may be adapted for leak containment. Specifically the facilities boxes may be fluid tight and may optionally include a drain or fluid pump, and/or may be maintained at a negative pressure and be coupled to an exhaust line. In a further aspect, the invention comprises a lockout mechanism for locking and tagging a cover of a facilities box.

The invention also comprises a method of standardizing semiconductor fabrication facilities by indicating a location within a fabrication facility for installing a facilities box; by providing a standardized facilities box; by providing a plurality of add-on features and by specifying which add-on feature should be selectively coupled to which selective coupling mechanism of the standardized facilities box.

Other features and advantages of the present invention will become more fully apparent from the following detailed description of the preferred embodiments, the appended claims and the accompanying drawings.

### BRIEF DESCRIPTION OF THE DRAWINGS

FIG. 1 is a schematic top perspective view of manufacturing equipment installed at a manufacturing location in accordance with the prior art;

FIG. 2 is a schematic top perspective view of the proposed SEMI rectangular support pedestal installed at a manufacturing location;

FIG. 3 is a schematic top perspective view of the proposed SEMI rectangular support pedestal with manufacturing equipment installed on the support pedestal;

FIG. 4 is a schematic top perspective view of one embodiment of an inventive support pedestal;

FIG. 5 is a schematic top perspective view of the support pedestal of FIG. 4 installed at a manufacturing location and having manufacturing equipment mainframe attached thereto;

FIG. 6 is a schematic top perspective view of an alternative embodiment of the support pedestal of the present invention installed at a manufacturing location;

FIG. 7 is a schematic top perspective view of the support pedestal of FIG. 6 installed at a factory location with manufacturing equipment installed thereon;

FIG. 8 is a schematic top perspective view of the support pedestal of the present invention installed below the level of a raised floor;

FIG. 9 is a side view of the embodiment of FIG. 8 with manufacturing equipment installed thereon;

FIG. 10 is a side view of gooseneck connectors at an inventive facilities connection locator;

FIG. 11 is an isometric view, taken from above, of a manufacturing equipment support apparatus, showing an improved facilities connection locator coupled thereto;

FIG. 12 is an exploded close up isometric view of the facilities connection locator of FIG. 11, taken from above;

FIG. 13 is an isometric side view, taken slightly from below, of a facilities connection line of FIG. 11;

FIG. 14 is a side view showing the facilities connection line of FIG. 13 coupled to a facilities connection port in a fixed relationship;

FIG. 15A is a bottom isometric view of a first fluid line connector;

FIG. 15B is a bottom isometric view of a second fluid line connector;

FIG. 16 is an exploded close up isometric view of the facilities connection locator of FIG. 11, taken from below;

FIG. 17 is a close up isometric view of the facilities connection locator of FIG. 11 taken from above and at an angle that better shows a riser surrounding a facilities connection plate thereof;

FIG. 18 is an isometric view, taken from above, of a manufacturing equipment support apparatus, showing an improved facilities connection locator coupled thereto and having additional features not shown in FIG. 11;

FIG. 19 is a top isometric view of an exemplary standardized facilities box;

FIG. 20 shows the standardized facilities box of FIG. 19 having a plurality of add-on features coupled thereto;

FIG. 21 is a side elevational view showing a pair of the standardized facilities boxes of FIG. 19 coupled together;

FIG. 22 is a top plan view of a standardized facilities box having a bridge flange and filler plate coupled thereto; and

FIG. 23 is a close up perspective view, taken from the side, showing an exemplary locating mechanism coupled in a tongue and groove manner to a unistrut rail type coupling mechanism

### DESCRIPTION OF THE PREFERRED EMBODIMENT

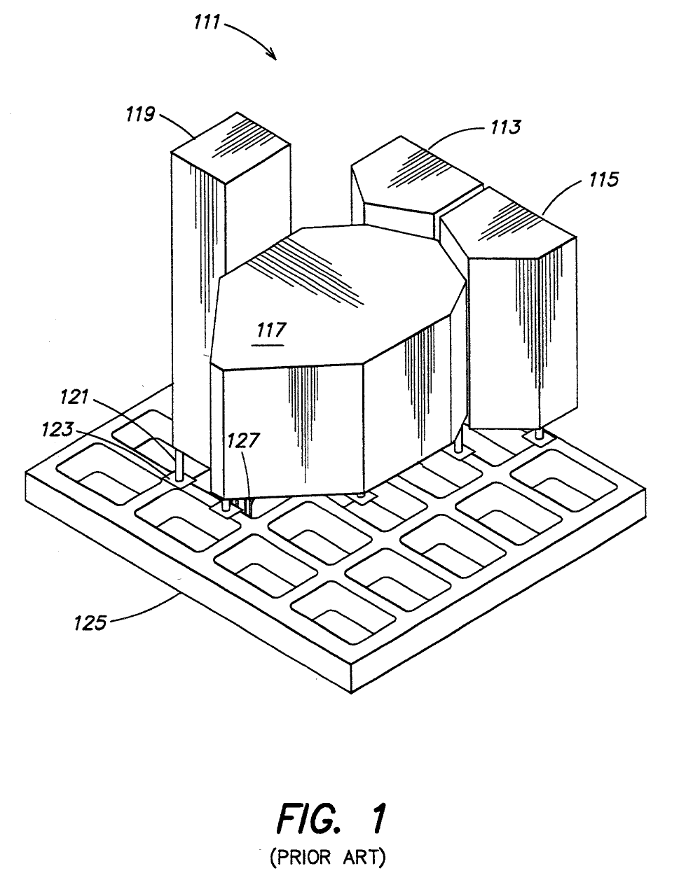

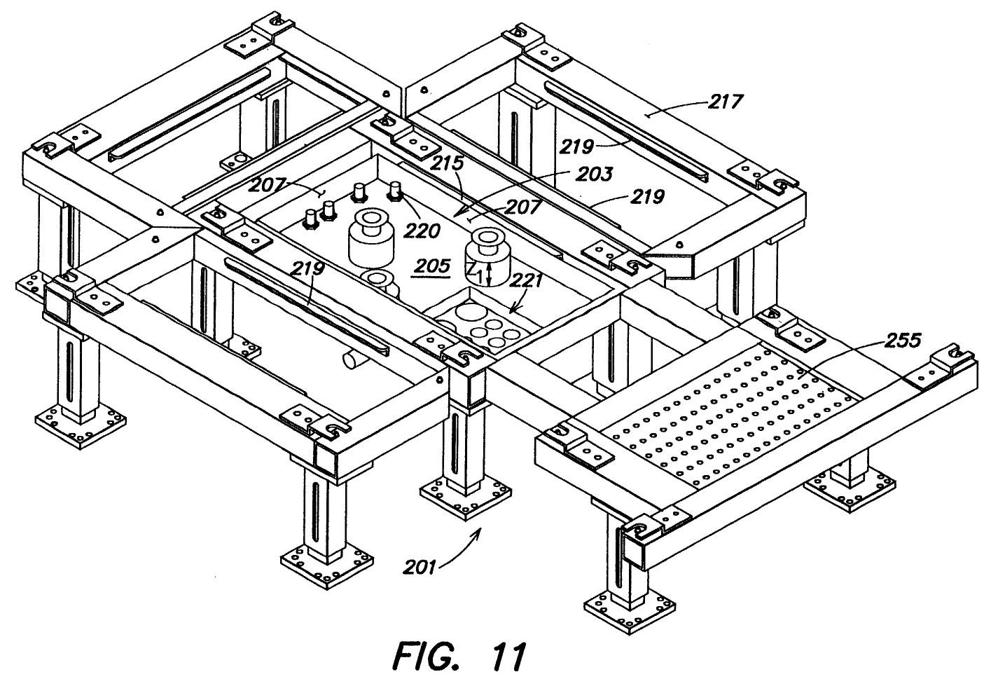

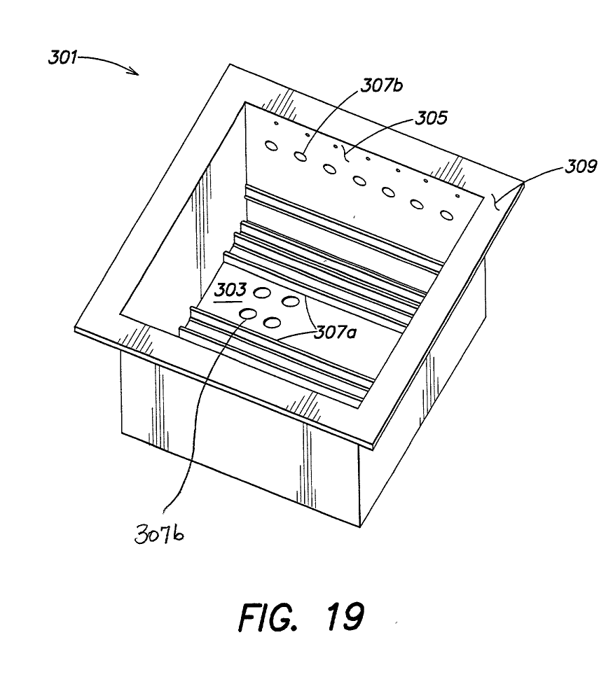

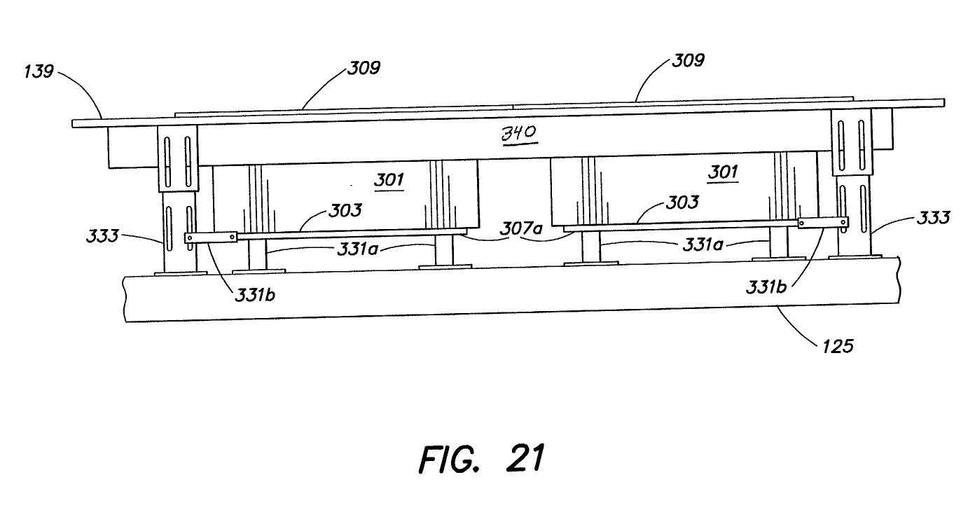

The present invention provides an inventive standardized facilities box. The standardized facilities box is modular, allowing for easy adaptation from one installation to the next. Features of the inventive standardized facilities box allow the box to be easily coupled to support pedestals (for equipment or flooring) of various sizes. A similar feature provides a filler plate sized to occupy the empty floor space that occurs when a removed floor tile is larger than the standardized facilities box that is installed. Additionally, a support leg feature allows the inventive facilities box to be coupled only to the tiles of a raised floor, rather than to a support pedestal. The inventive standardized facilities box is described in detail with reference to FIGS. 19 and 21. In one aspect the inventive standardized facilities box may contain/capture fluid and/or vapor leaks of facilities lines that connect therethrough. In other aspects, however, the inventive standardized facilities box may have a cover that is level with the raised floor, and may be used to store tools, or documents, etc. and may have no facilities lines connected therethrough. The specific equipment pedestals described with reference to FIGS. 1-10 are exemplary pedestals to which the inventive standardized facilities box may be coupled, and the facilities connectors/locators of FIGS. 11-18 describe leak containment and z-axis locators that may be employed with the modular standardized facilities box of the present invention.

FIG. 1 is a schematic top perspective view of manufacturing equipment installed at a manufacturing location in accordance with the prior art. As depicted therein, manufacturing equipment 111, shown as semiconductor processing equipment including two loadlock chambers 113 and 115, a mainframe 117 and one or more processing chambers 119 (only one shown), is supported by a plurality of support legs 121 which extend from mounting feet (not shown) on the bottom of the manufacturing equipment 111 down to base mount location pads 123 disposed on an underlying waffle-grid floor 125. Typically each of the support legs 121 is custom fabricated for the installation, in order to assure that the manufacturing equipment 111 is level, and also so as to connect the support legs to the interstices of the waffle sub-floor. Generally, the suppliers of the manufacturing equipment 111 will provide mounting feet (not shown) which are of adjustable height. In that way upon final installation of the manufacturing equipment 111, when each of the mounting feet is attached to a support leg 121, final leveling of the manufacturing equipment 111 can be conducted by adjusting the height of each of the mounting feet. While a manufacturing location will have facilities lines 127 brought to the manufacturing level, further plumbing is required for connection of the facilities lines 127 to the manufacturing equipment 111 after the physical installation (i.e., anchoring of the manufacturing equipment 111 on support legs 121 and leveling thereof) is completed. As noted above, disadvantages of the FIG. 1 prior art installation include the additional time and cost for providing customized support legs 121 and the difficulty in pre-planning or pre-facilitating the manufacturing location due to the fact that the locations of the support legs 121 may interfere with pre-plumbed facilities lines 127.

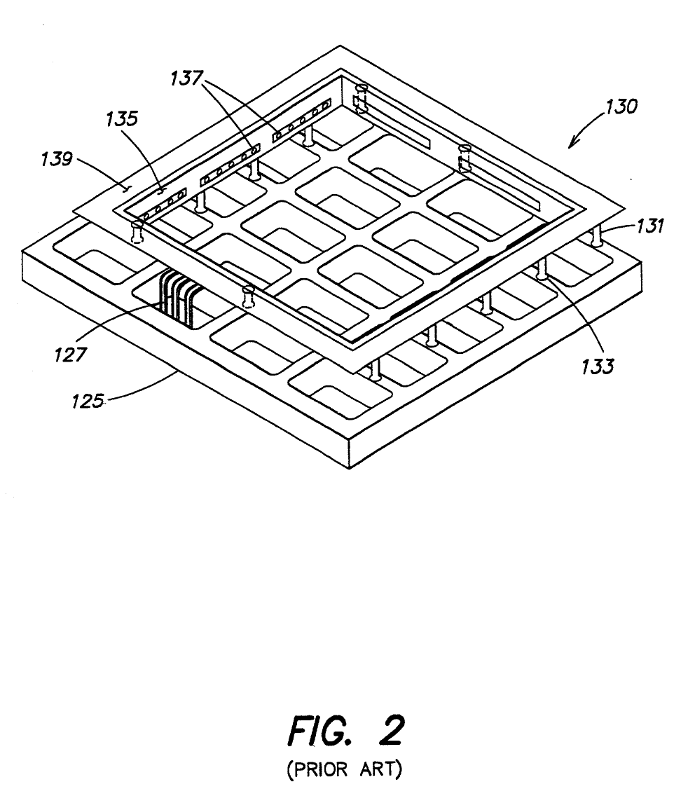

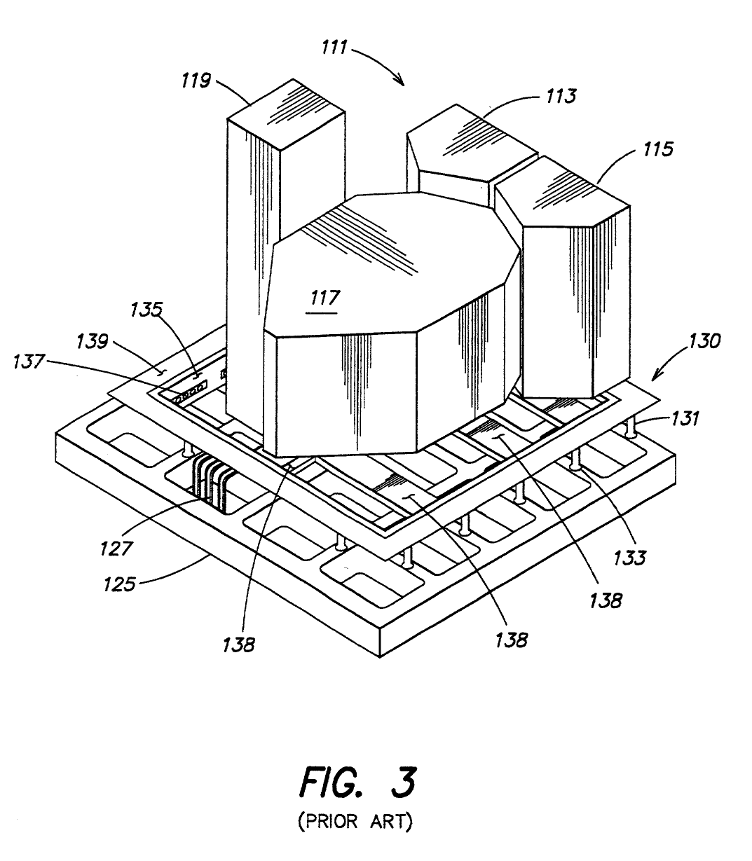

FIG. 2 is a schematic top perspective view of the proposed rectangular SEMI support pedestal 130 installed at a manufacturing location. The SEMI support pedestal 130 provides an alternative to the customized support legs 121 of FIG. 1. The SEMI support pedestal 130 comprises a rectangular pedestal frame 135 supported on a plurality of SEMI support pedestal legs 131, each of which is aligned to or near one of the interstices of the waffle-grid floor 125. The SEMI pedestal frame 135 includes a plurality of SEMI facilities connection locations 137 for establishing pre-facilitation locations to which facilities lines 127 can be pre-plumbed prior to the installation of the manufacturing equipment 111 of FIG. 3. The SEMI pedestal frame 135 additionally may be adapted to support raised flooring 139.

FIG. 3 is a schematic top perspective view of the proposed SEMI support pedestal 130 with manufacturing equipment 111 installed thereon. With like reference numerals indicating previously-referenced components, FIG. 3 depicts the SEMI support pedestal 130 having a rectangular SEMI pedestal frame 135 disposed on a plurality of SEMI pedestal support legs 131 which extend down to base mount locations on the waffle-grid floor 125. SEMI facilities connection locations 137 are provided along the SEMI pedestal frame 135 as pre-facilitation locations for connection of facilities lines 127. When manufacturing equipment 111 is installed on the SEMI support pedestal 130, crossbeam members 138 typically must be attached to the SEMI pedestal frame 135 to support the manufacturing equipment 111, and to transfer and distribute the weight of the manufacturing equipment 111 to the SEMI support pedestal 130. Given the fact that the manufacturing equipment 111 has a unique shape, the installation of the manufacturing equipment 111 on a SEMI support pedestal 130 requires “customization” for both support and facilities connections.

The SEMI support pedestal 130, by attachment and alignment to the top edge of the SEMI pedestal frame 135, does provide the alignment and leveling reference points for installation of manufacturing equipment 111, and provides pre-plumbing reference points (i.e., the facilities connection locations 137). Nonetheless, the installation of the manufacturing equipment 111 requires customized support fabrication of the crossbeam members 138 and/or cantilevers (not shown), and customized retrofitting for connecting the facilities lines 127 from the facilities connection locations 137 to the actual facilities connection points (not shown) on the manufacturing equipment 111. As noted above, modifications to certain facilities lines can adversely affect the flow through those lines to the potential detriment of both the manufacturing process and the manufacturing equipment 111.

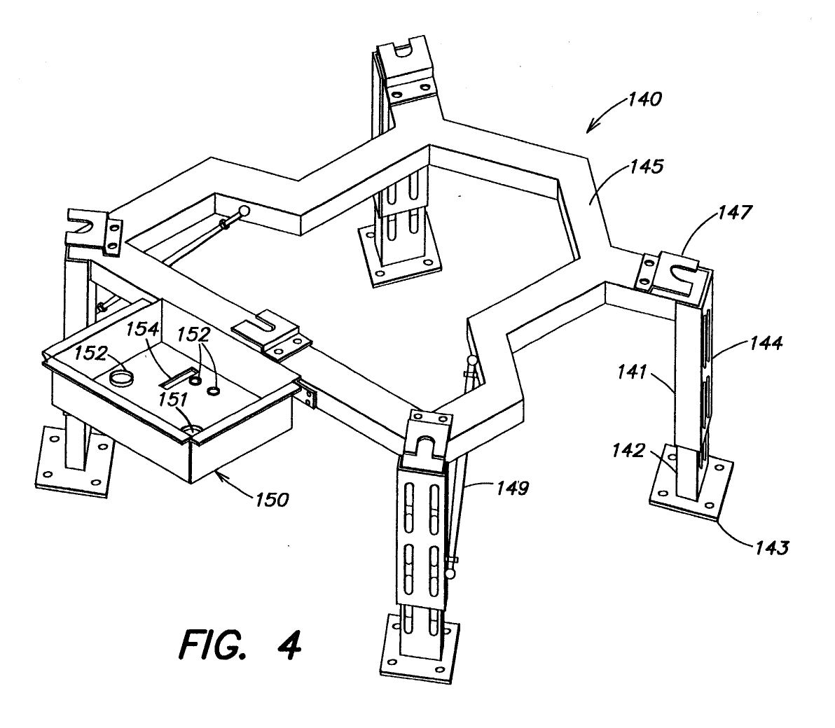

FIG. 4 is a schematic top perspective view of an inventive support pedestal 140. The inventive support pedestal 140 comprises a support frame 145 having a plurality of support legs 141 extending downward therefrom. The support frame 145 has a frame outline which substantially duplicates the bottom outline of the mainframe 117 of the manufacturing equipment 111, with the “bottom outline” of the mainframe 117 being defined by the lower frame of the mainframe 117 itself. In one aspect the support frame 145 may be monolithic so as to provide the enhanced support integrity which comes from a “seamless” frame. The support frame 145 includes brackets 147 for engaging the load-bearing mounting feet of the manufacturing equipment (if any).

The support legs 141 are adjustable and comprise an outer leg section 144 fixedly mounted (e.g., bolted or welded) to the support frame 145, and an inner leg section 142. The inner leg section 142 is slideably mounted in the outer leg section 144, so that the length of the support legs 141 can be adjusted and, once optimized, locked in place by bolting or welding the inner leg section 142 to the first outer leg section 144. The support legs 141 are disposed on base mount location pads 143, which can be affixed (e.g., removably via bolts, or welded) to the support legs 142 prior to installation or can be provided at the installation site. Additionally affixed to the support legs 141 are optional seismic braces 149. A first end of each seismic brace 149 is fixedly mounted to a support leg 141 as shown, (or alternatively could be attached directly to the waffle grid flooring) while a second end of the seismic brace 149 is provided for attachment to the manufacturing equipment 111 upon installation thereof.

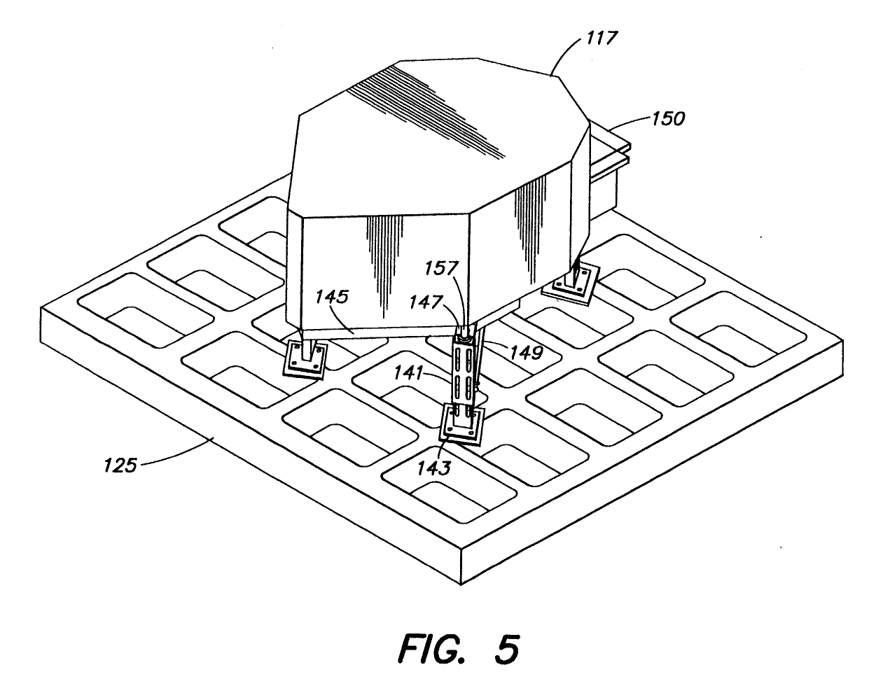

The inventive support pedestal 140 includes at least one facilities connection locator 150 which is fixedly mounted to the support frame 145 and which establishes the facilities connection locations, representatively shown as the four facilities connection locations 151-154, which exactly match the facilities connection points on the manufacturing equipment 111. Optional outer flanges (not shown) at the periphery of the support frame 145, as well as optional inner flanges (not shown) are provided for supporting raised flooring (as shown in FIG. 5).

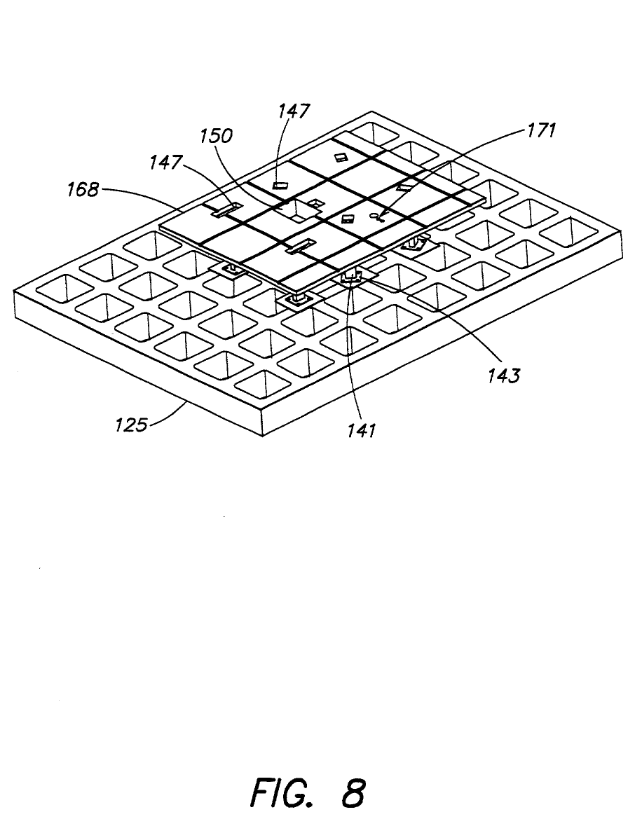

FIG. 5 is a schematic top perspective view of the inventive support pedestal 140 of FIG. 4, installed at a manufacturing location and having the mainframe 117 attached thereto. The inventive support pedestal 140 includes the support frame 145, having a frame outline which substantially duplicates (and preferably exactly duplicates) the bottom outline of the mainframe 117, and a plurality of support legs 141, each of which extends to a base mount location pad 143 positioned on the waffle-grid floor 125. In at least one embodiment of the invention, the frame outline need not substantially (or otherwise) duplicate the bottom outline of the mainframe 117. Seismic braces 149 are attached to the support legs 141 and to the mainframe 117. The facilities connection locator 150 is attached to the support frame 145 to provide the fixed facilities connection locations 151-154 (shown in FIG. 4). The illustrated support pedestal 140 may have raised flooring (not shown) attached at the periphery of the support frame 145. It is to be noted that the support pedestal 140 can alternatively be installed just below the level of the raised flooring, as depicted in FIG. 8 (discussed herein below).

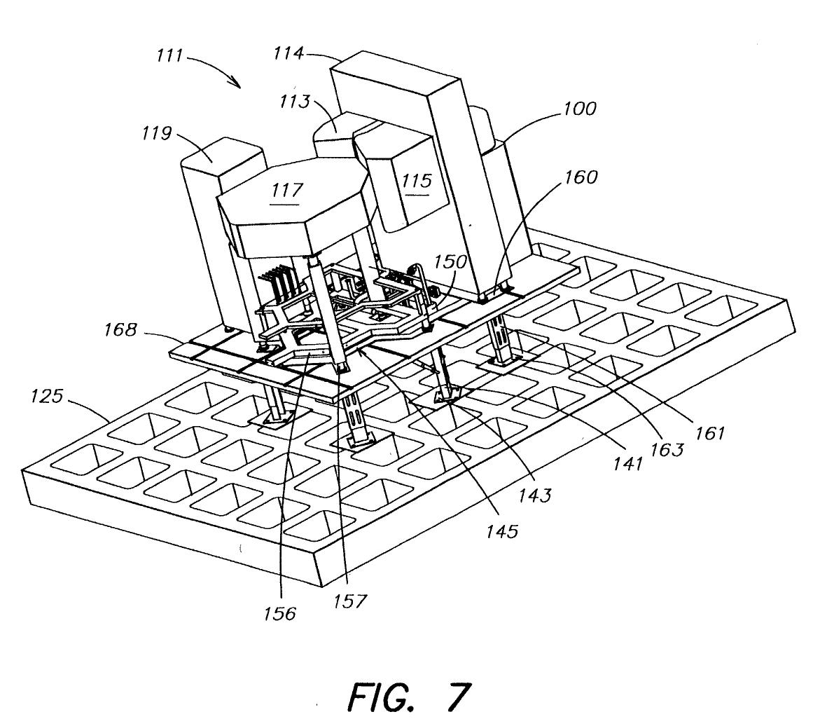

The inventive support pedestal 140 provides manufacturing equipment alignment (due to the shape of the pedestal frame 145) and leveling (due to the adjustable legs), as well as providing fixed facilities connection locations 151-154, all of which can be established in advance of the manufacturing equipment installation with reference to a datum point 100 (FIG. 7) of the factory location. That is, a datum point is identified at the factory location and the support pedestal is aligned, leveled and plumbed with reference thereto. Since the frame outline of the support frame 145 matches the bottom outline of the mainframe 117 of the manufacturing equipment which is installed on the support frame 145, and since the quantity and positioning of the plurality of support legs 141 has been adapted to engage the manufacturing equipment's load-bearing mounting feet for support of the particular manufacturing equipment being supported by the inventive support pedestal 140, no additional support structures (such as the custom-fabricated steel jacks, concrete piers, crossbeams or cantilevers) are required. Furthermore, given the fact that all of the facilities connection locations 151-154 of the facilities connection locator 150 are pre-aligned to the facilities connection points on the manufacturing equipment itself, no retrofitting of facilities lines and connectors is required, thereby avoiding interference with flow patterns within the facilities lines. Using the factory location's datum point, therefore, the factory location can be pre-facilitated with all of the facilities lines pre-plumbed to the specified location of the facilities connection locations 151-154 at the facilities connection locator 150.

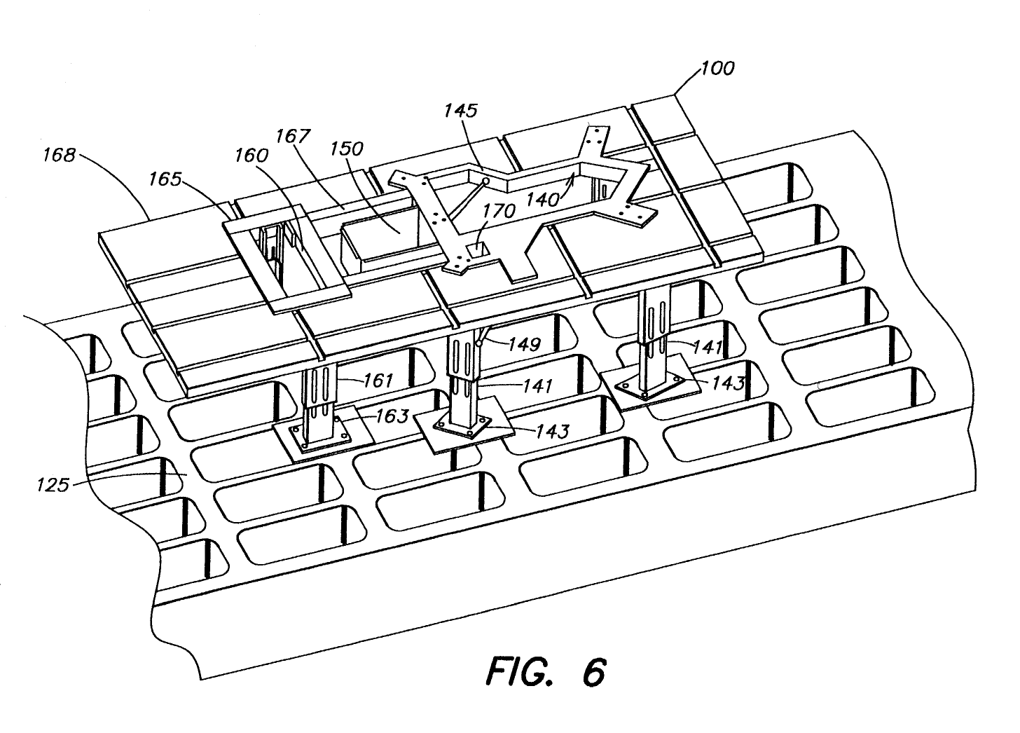

The support pedestal 140 is adaptable to specific manufacturing equipment configurations, as illustrated in FIG. 6. For the installation of a semiconductor processing system, such as is depicted in FIG. 1, which includes not only the mainframe processing unit 117 but also the factory interface 114 with loadlock 113 and 115 and a process chamber 119, the support pedestal 140 can be augmented with at least one additional support 160, including an additional frame 165 supported by additional support legs 161 extending to additional base mount location pads 163 to support the factory interface 114, the loadlocks 113, 115 or the processing chamber 119 (FIG. 1). The components of the addition support 160 may be configured in the same manner as the components of the support pedestal 140 with adjustable legs 161 positioned below load bearing mounting of the manufacturing equipment positioned on the additional support 160 and/or frame 165 that duplicates the bottom of the manufacturing equipment. The additional support component 160 may be joined to the support pedestal 140 by connecting segments 167. Alternatively, however, the pedestal frame 140 can be extended to include the support for the additional manufacturing equipment (e.g., the processing chamber 119). Thus, a single support pedestal 140 may be configured to support one or more pieces of manufacturing equipment or a plurality of support pedestals may be coupled directly or via a connecting segment 167. In this example of FIG. 5, the support pedestal 140 includes an additional facilities connection locator 170 with additional facilities connection locations (171 of FIG. 8) as needed (e.g., for the additional processing chamber 119).

FIG. 7 is a top perspective view of the support pedestal 140 at a factory location with the manufacturing equipment 111, including the factory interface 114, the loadlocks 113 and 115, the mainframe processing unit 117 (shown partially cut away so that the bottom footprint thereof is visible) and the additional processing chamber 119 installed thereon. The illustrated additional processing chamber 119, like the factory interface 114, may be supported independently as described with reference to FIG. 6. The factory interface 114 is supported by the additional support component 160 comprising additional frame component 165 supported by additional support legs 161 which extend down to additional base mount location pads 163.

The mainframe 117 of the manufacturing equipment 111 is mounted on the support frame 145, which is in turn supported by support legs 141 which extend to the base mount location pads 143 coupled (e.g., welded or bolted) to the waffle-grid flooring 125. In the FIG. 7 embodiment, the mainframe processing unit 117 has been provided by the manufacturing equipment supplier on its own mounting frame 156 to which load-bearing mounting feet 157 are affixed. In such an embodiment, the bottom outline of the mainframe 117 is defined by the locations of the load-bearing mounting feet 157 as mounted to the mounting frame 156 (provided by the manufacturing equipment supplier) for the mainframe 117.

FIG. 8 is a schematic top perspective view of the support pedestal 140 of the present invention installed below the level of the raised flooring 168. In such an alternate embodiment, the support frame 145 (not shown) would be installed on support legs 141 which extend down to base mount location pads 143 on the waffle-grid flooring 125 as in the previously-described embodiments. Raised flooring 168 would be installed on top of the support pedestal 140, with openings provided for the facilities connection locator 150 of the mainframe 117 (not shown), for the additional facilities connection locations 171 of the additional facilities connection locator (not shown) which is provided for the additional processing chamber 119 (not shown), and for the brackets 147 which will engage the load-bearing mounting feet 157 of the manufacturing equipment 111.

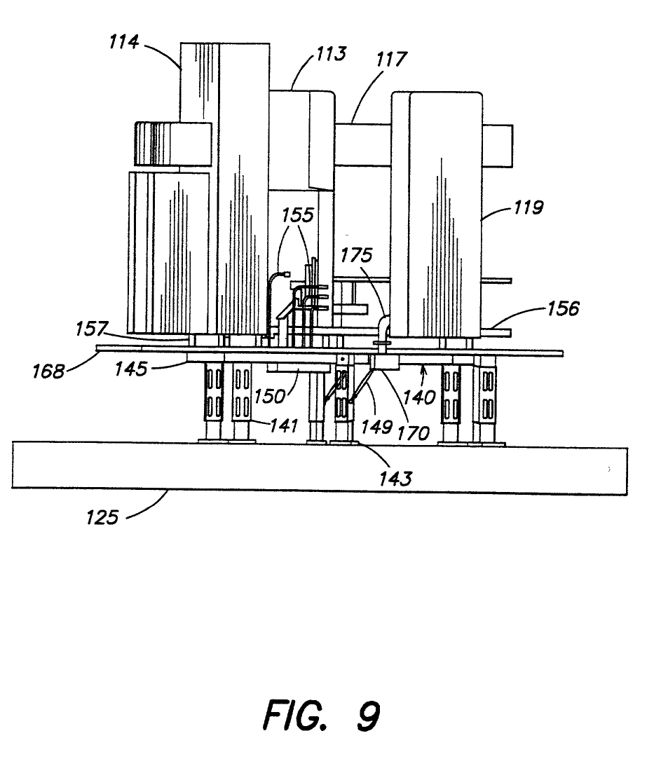

FIG. 9 is a side view of the embodiment of FIG. 8 with manufacturing equipment 111 installed thereon. As shown therein, the raised flooring 168 has the openings for brackets 147 (FIG. 8) which accommodate load-bearing mounting feet 157. The mainframe processing unit 117 is provided on its mounting frame 156 which includes load-bearing mounting feet 157 to be attached to the brackets 147 (FIG. 8) of the underlying support pedestal 140. The support frame 145 of the support pedestal 140 is fixedly attached to the plurality of support legs 141, each of which extends to and is coupled to the base mount location pads 143 on the waffle-grid floor 125. Facilities connections 155 are shown projecting up from the facilities connection locations 151-154 (not shown) of facilities connection locator 150 to be provided to the mainframe processing unit 117. The additional processing chamber 119 has additional facilities connections 175 extending up through its additional facilities connection locations 171 (FIG. 6) associated with the additional facilities connection locator 170.

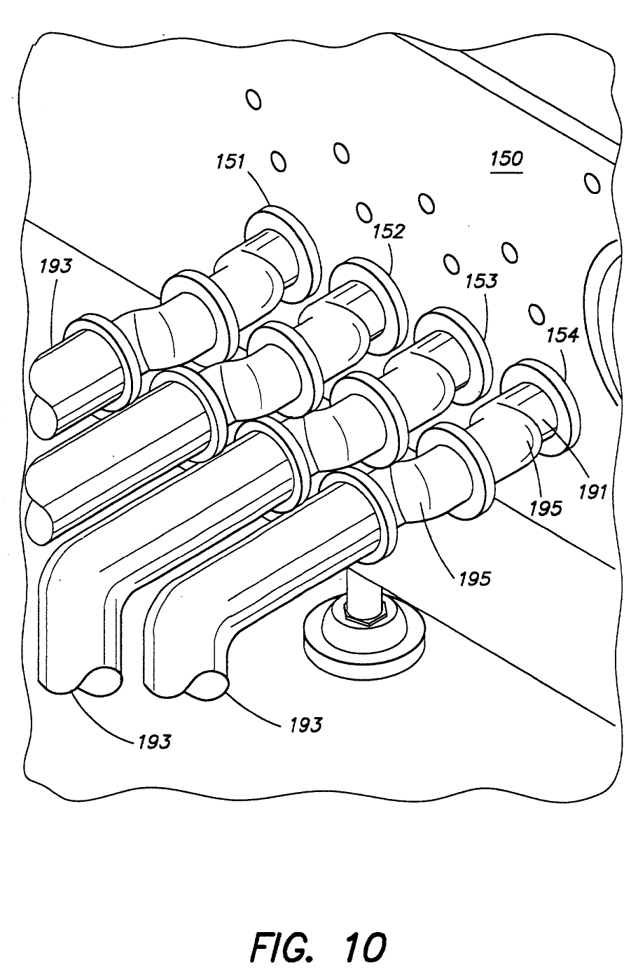

FIG. 10 is a side view of gooseneck connectors 191 which provide facilities connection between the facilities supply lines 193 of a factory location and the facilities connection locations 151-154 of a facilities connection locator 150 of the present invention (or any other facilities connection locations). The gooseneck connectors 191 comprise a plurality of connector segments 195 which are alternately oriented to flexibly approximate a “straight” flow path between the facilities supply lines 193 and the facilities connection locations of the facilities connection locator 150.

The invention has been described with reference to several specific embodiments. One having skill in the relevant art will recognize that modifications may be made without departing from the spirit and scope of the invention. For example, it is to be noted that the manufacturing equipment 111 may include some non-load-bearing feet (hereinafter referred to as “anchoring feet”) which may be provided for additional lateral securing of the manufacturing equipment to the support frame 145. The number and locations of the support legs 141 of the inventive support pedestal 140 are selected to match the number and locations of the load-bearing mounting feet 157 on the bottom outline of the manufacturing equipment. It is to be understood that, without departing from the invention as taught and claimed, additional anchoring feet may be provided on the manufacturing equipment, and additional brackets for engaging the anchoring feet may be provided on the inventive support pedestal 140 in locations which may or may not align with support legs 141.

In addition, the illustrated seismic braces, including variable length ball-end rods 149 of FIG. 4, are merely representative of one embodiment of the optional feature. An alternative embodiment would include a piece of thick metal strapping, which would first be secured to the support leg, followed by custom-bending in situ, and then bolting or welding into place. By either method, the support pedestal would be triangulated in orthogonal directions, thus preventing the vertical support legs from deforming to the point of failure during a seismic event.

While it has been taught that a molded, monolithic pedestal frame is advantageous for mechanical integrity, clearly a pedestal frame comprising a plurality of bonded (e.g., welded) or fixedly coupled (e.g., bolted) pieces can be substituted without departing from the invention as claimed.

Yet another modification comprises the use of standardized spacers as the mounting and anchoring feet, in place of the adjustable mounting and anchoring feet which have traditionally been employed for in situ leveling of manufacturing equipment. The inventive support pedestal has adjustable legs which are adjusted prior to installation of the manufacturing equipment to thereby pre-establish the alignment and leveling of the manufacturing equipment; therefore, fixed spacers are recommended since the fixed spacers maintain the fixed parallel relationship between the support frame and the manufacturing equipment which has been established relative to the datum point and since no in situ leveling of the manufacturing equipment will be required.

The support leg sections could also be tubular, right angle sections (“angle iron”), or triangular or etc., they need not be rectangular. Also, the lower portion of the support leg could be either the outer or the inner portion. As an alternative to being bolted-on, the mounting of the support legs to the pedestal frame could also be welded-on, designed so that they would attach underneath the frame (in compression), or designed to fit into underside receptacles fabricated as part of the frame itself, or some combination of these.

Finally, pre-facilitation of a factory location can be conducted using a “map” of the support pedestal and its facilities connection locator with facilities connection locations defined relative to a datum point of the factory location. A medium (polycarbonate film) having a full-scale outline of the inventive support pedestal, with or without facilities connection locations denoted, can be delivered to the factory location prior to installation of the support pedestal. Once the polycarbonate film is spread out on the factory floor relative to the datum point, the x and y coordinates (i.e., the coordinates in the horizontal plane) for each facilities connection location will be precisely defined in situ and appropriate plumbing, electrical, construction can be performed prior to installation of the inventive support pedestal.

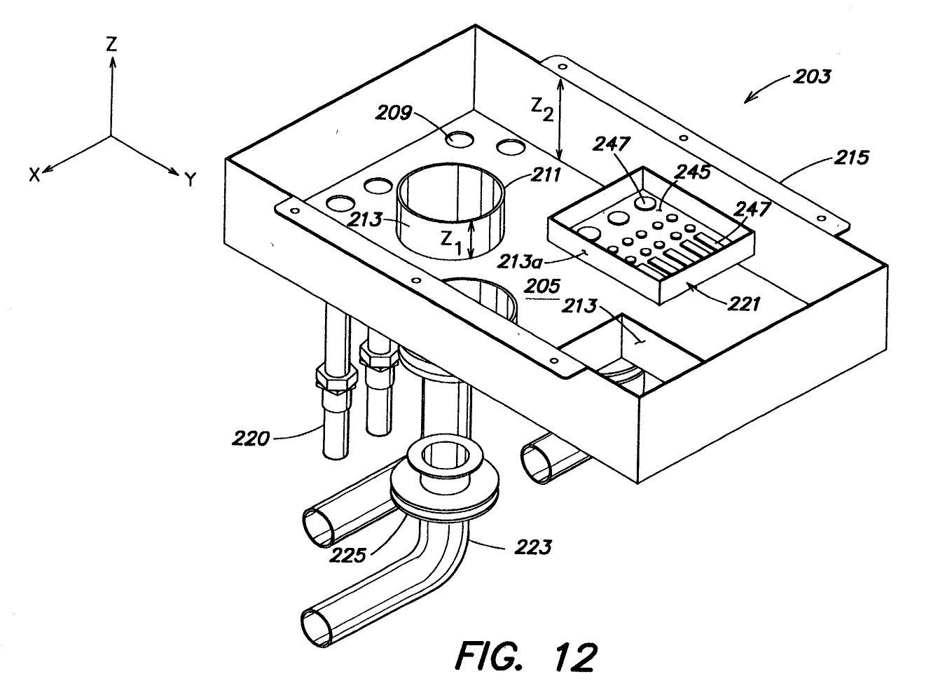

FIG. 11 is an isometric view, taken from above, of a manufacturing equipment support apparatus 201, showing an improved facilities connection locator 203 coupled thereto. The facilities connection locator 203 comprises a bottom surface 205 and a plurality of side walls 207 extending upwardly therefrom so as to form a fluid tight “bucket.” The facilities connection locator 203 has at least one fluid connection port formed therein and may also have any number of vacuum connection ports, and/or facilities connection plates, the features of which are best understood with joint reference to FIG. 11 and to FIGS. 12-17 which show various view of the facilities connection locator 203 and/or its facilities line connectors.

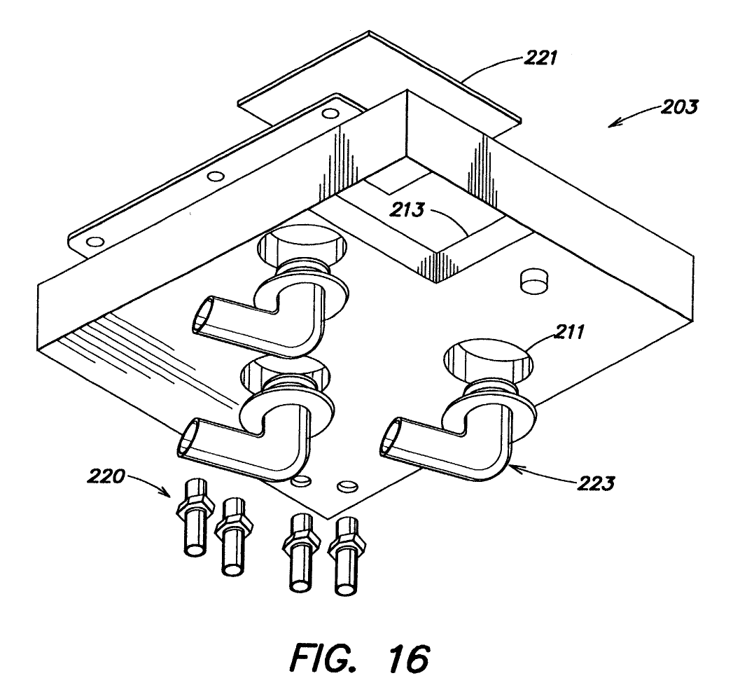

The exemplary facilities connection locator 203 shown comprises four fluid connection ports 209 (FIG. 12) and three vacuum connection ports 211 (FIG. 12 and FIG. 16). Each vacuum connection port 211 is shown surrounded by a riser 213.

A mounting mechanism (such as mounting flanges 215) extends from the facilities connection locator 203 and interfaces with features of the equipment support apparatus 201 so that the facilities connection locator 203 is mounted to the equipment support apparatus 201 with a predetermined relationship (i.e., such that features of the facilities connection locator 203 are fixed in the x-axis and y-axis directions relative to the outline or footprint of the equipment support apparatus 201, and are fixed in the z-axis direction relative to a top surface 217 of the equipment support apparatus 201). In the exemplary embodiment shown, the mounting flanges 215 of the facilities connection locator 203 rest on corresponding mounting flanges 219 located within the footprint of the equipment support apparatus 201 and recessed slightly below the top surface 217 of the equipment support apparatus 201 such that the top surface of the facilities connection locator 203 and the mounting flanges 215 thereof is flush with the top surface 217 of the equipment support apparatus 201.

Consider, for example the riser 213, each of which extends a predetermined height Z₁, above the bottom surface 205. Accordingly, because the bottom surface 205 is a predetermined height Z₂ below the top surface 217, the z-axis position of the top of the riser 213 is known relative to the top surface 217. The same principle is true for the remaining features of the equipment support apparatus 201, such as the z-axis position of any fluid line connectors 220 relative to the top surface 217 or the z-axis position of any facilities connection plate 221 relative to the top surface 217.

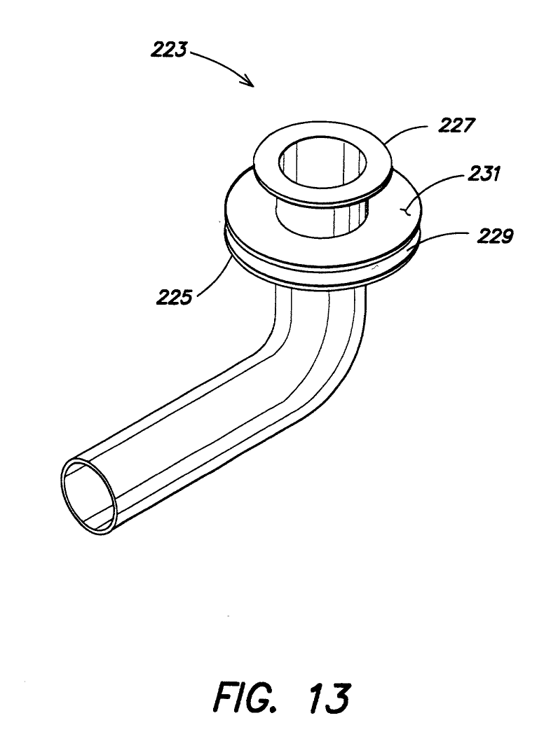

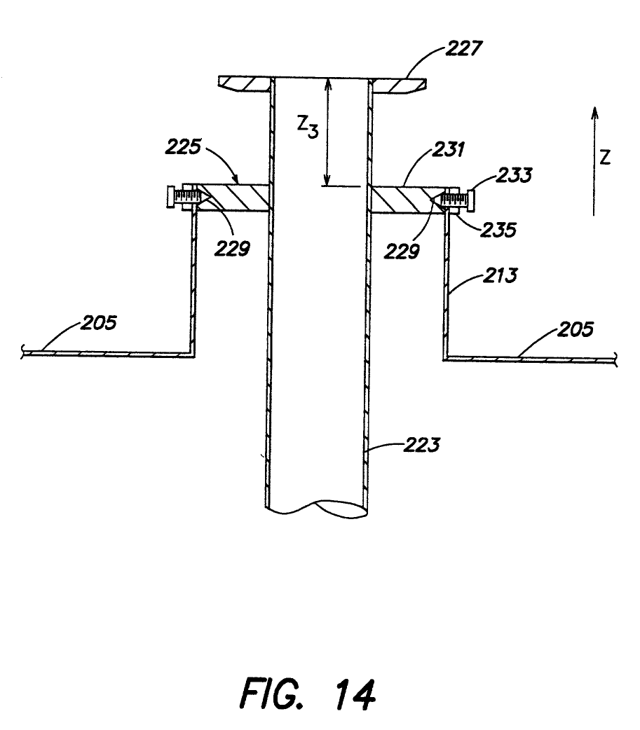

The riser 213 may be employed with a facilities connection line 223 having a z-axis locating mechanism such as a locating flange 225, best understood with reference to FIGS. 13 and 14. As shown in FIGS. 13 and 14, the facilities connection line 223 has a top surface 227 which may comprise a flange, as shown. The top surface 227 has a fixed height relationship Z₃ with respect to the top of the riser 213 (FIG. 14). Thus, as the top of the riser 213 has a fixed z-axis position with respect to the top surface 217, so does the top surface 227.

In order to facilitate accurate z-axis positioning/mounting between the locating flange 225 and the riser 213, the locating flange 225 may comprise a V-shaped groove 229, and the riser 213 may comprise a plurality of holes (not shown) formed at a predetermined height above the bottom surface 205. In one aspect the V-shaped groove 229 and the holes (not shown) in the riser 213 are configured such that when a top surface 231 of the locating flange 225 is flush with the top surface of the riser 213, the center of the V-shaped groove 229 is adjacent the holes. A screw 233 may then be threaded through a nut 235 and through the hole in the riser 213 so as to extend into the center of the V-shaped groove 229. As will be apparent, the nut 235 ensures that the screw 233 is normal to the hole in the riser 213, and the normally positioned screw 233 contacts the equally sloped sides of the V-shaped groove 229 ensuring that the facilities connection line 223 is precisely positioned in the z-axis direction. Although the facilities connection line 223 is shown only as a vacuum line connection in the figures, it will be understood that the facilities connection line 223 also may be employed as a fluid line connector.

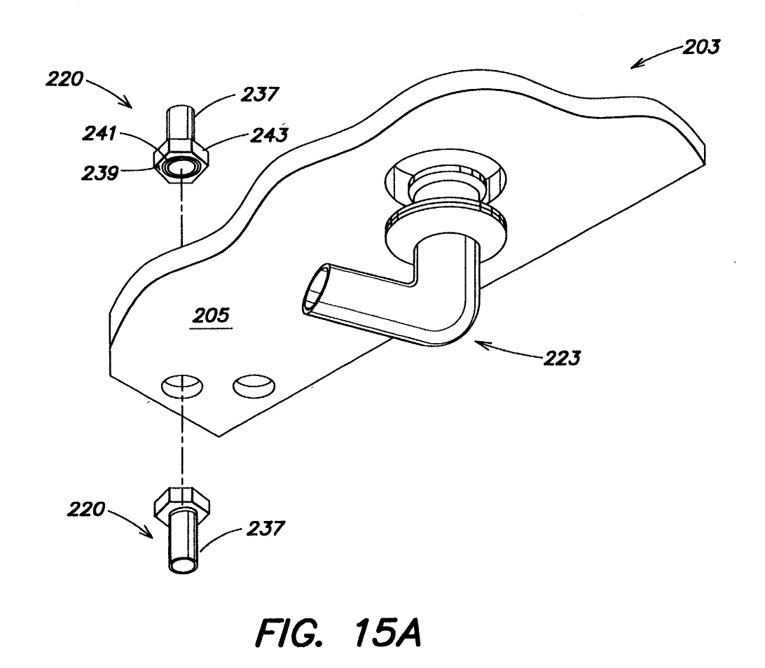

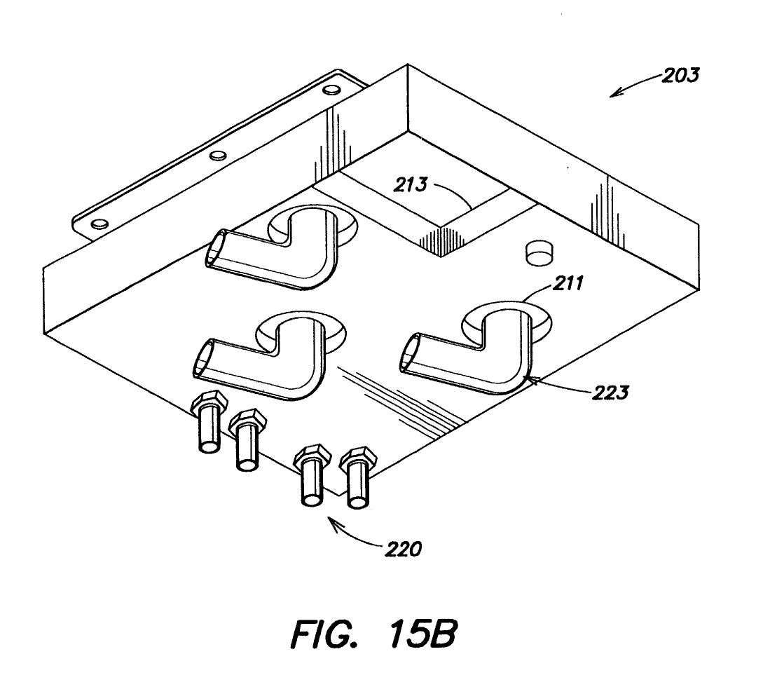

In one aspect, the fluid line connectors 220 may be configured as shown in the bottom isometric view of FIG. 15A. Each fluid line connector 220 comprises a fluid line 237 having a planar surface 239 that extends horizontally from the fluid line 237 and, when coupled to the facilities connection locator 203, is positioned such that the planar surface 239 extends along the interior side of the facilities connection locator 203's bottom surface 205. An o-ring 241 is disposed along the planar surface 239 so as to form a fluid tight seal between the planar surface 239 and the interior side of the facilities connection locator 203's bottom surface 205. A portion of the fluid line 237 that is to extend downward from an exterior surface of the facilities connection locator 203's bottom surface 205 is threaded (not shown) so that a threaded bolt 243 may be threaded thereon, as shown. Thus, the bolt 243 may be tightened such that the o-ring 241 is held firmly between the planar surface 239 and the facilities connection locator 203's bottom surface 205, forming a fluid tight seal. Because the planar surface 239 has a fixed offset from the top of the fluid line 237, and the fluid line 237 has a known height, the top of the fluid line 237 is a fixed or known distance from the bottom surface 205 of the facilities connection locator 203, and from the top surface 217.

Any of the connections described above may also be welded to the facilities connection locator 203, as shown in FIG. 15B. By welding or otherwise integrally forming vacuum and/or fluid line connectors to the bottom surface 205, the facilities connection locator 203 is fluid tight without the need for the special fluid tight design of the fluid line connectors 220 described above, and without the need for the riser 213. Further, the welded or integrally formed fluid line connectors 220 and facilities connection lines 223 will have fixed positions (in the x-y and z axis) relative to the facilities connection locator 203 and hence relative to the top surface 217 of the equipment support apparatus. Such welded/integral fluid line connectors 220 and facilities connection lines 223 are shown in the isometric view of FIG. 15B, and may also have an optional industry standard clamp flange (not shown).

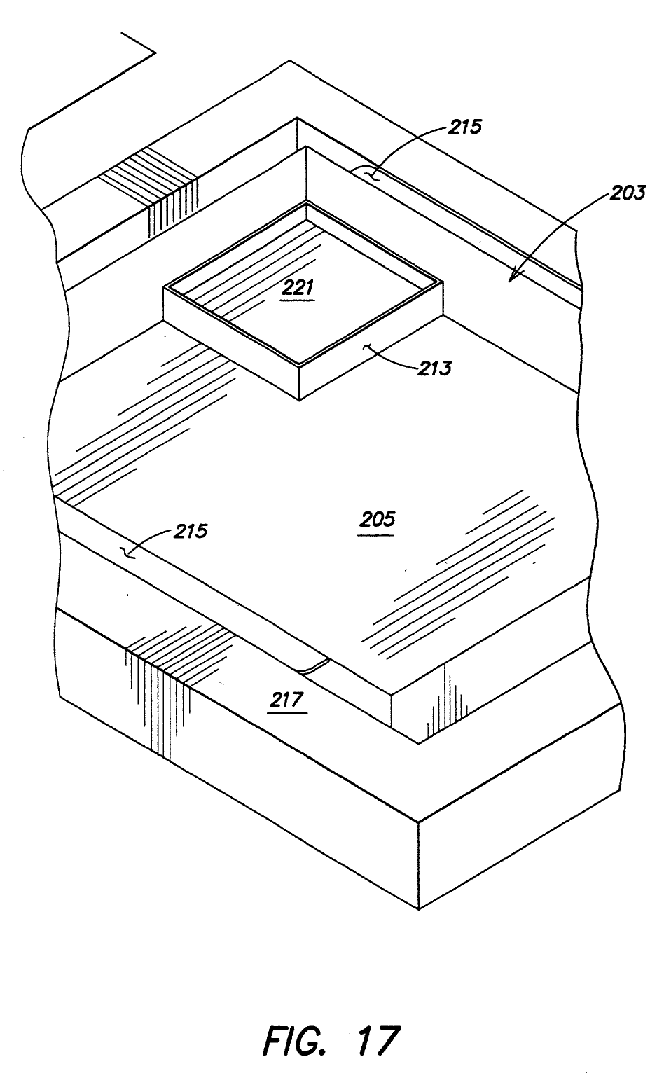

An optional feature of the facilities connection locator 203 is the facilities connection plate 221, which is best shown by FIGS. 16 and 17. FIG. 16 is an exploded close up isometric view of the facilities connection locator 203, taken from below; and FIG. 17 is a close up isometric view of the facilities connection locator 203 taken from above and at an angle that better shows a riser 213 that surrounds the facilities connection plate 221.

As with the vacuum connection port 211, the riser 213 surrounds the facilities connection plate 221 so that if fluid should fill the facilities connection locator 203, the facilities connection plate 221 will be protected therefrom. As best shown in FIG. 12 the facilities connection plate 221 may also have an integrally formed riser 213a which makes mounting of the facilities connection plate 221 easier. The integrally formed riser 213a may also have welded corners so as to be fluid tight. The connection plate's riser 213a is adapted to couple to the riser 213 so that a bottom surface 245 of the facilities connection plate 221 is a fixed height above the bottom surface 205 of the facilities connection locator 203, and thus, is a fixed height offset from the top surface 217. Alternatively, rather than a riser, the connection plate 221 may have an integral edge that extends downwardly to facilitate mounting of the connection plate 221. The facilities connection plate 221 has a plurality of removable panels 247 (e.g., knock out panels with perforated edges that facilitate easy removal) that may be individually removed to allow facilities lines (e.g., electrical, gas, fluid or pressure lines, etc.) to pass therethrough.

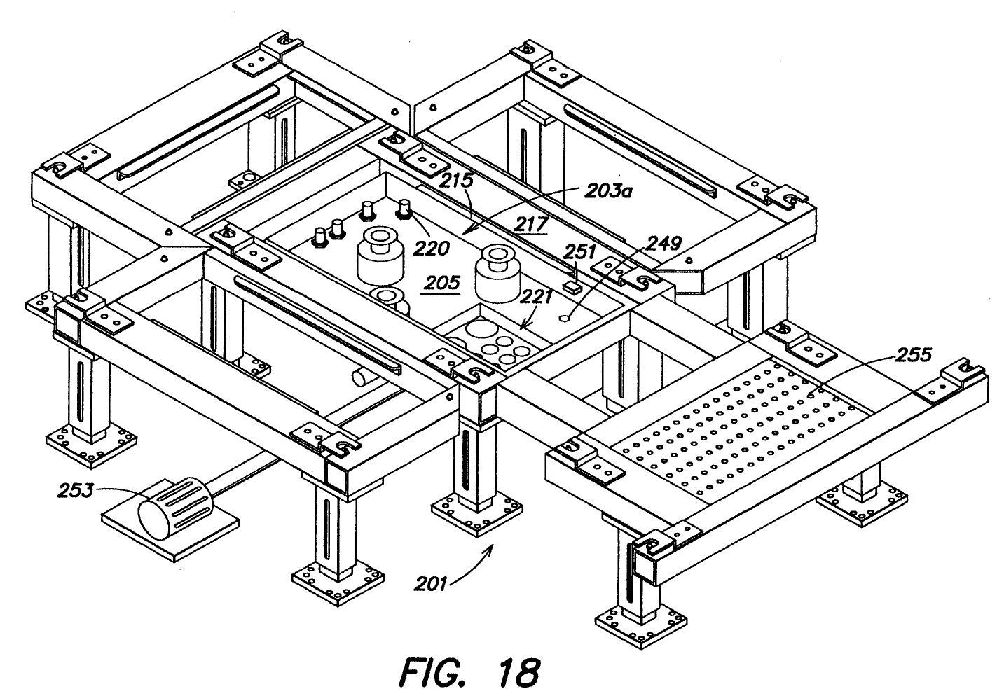

FIG. 18 is an isometric view, taken from above, of a manufacturing equipment support apparatus, showing an improved facilities connection locator 203a coupled thereto and having additional features not shown in FIG. 11. The facilities connection locator 203a has the additional feature of a gravity drain 249, located on the bottom surface 205 of the fluid tight bucket 203. The bottom surface 205 may be sloped, such that the drain 249 is at a slightly lower elevation than the remainder of the bottom surface 205. Also shown in FIG. 18 is a liquid level sensor 251 that detects when fluid in the facilities connection bucket 203 has reached a certain level. The liquid level sensor 251 may be coupled to a controller (not shown) that will notify an operator of the fluid level, will shut of the fluid flow through the fluid line(s) connected to the facilities connection locator 203 and/or will activate a fluid pump coupled to the facilities connection locator 203. A fluid pump 253 which automatically begins to pump fluid when it senses the same may also be employed.

A further feature that may be employed with any equipment support apparatus, is an airflow control plate 255 as shown in FIG. 11. The airflow control plate 255 may be mounted to the support apparatus via a plurality of flanges or any other suitable mechanism. The airflow control plate 255 has a plurality of openings (e.g., in a preferred embodiment evenly distributed holes of equal size) to control airflow. The plate may be adapted to fully or partially occupy an interior region of the support apparatus' frame outline. Accordingly, where gaps exist between the installed equipment and the pedestal's top surface, the airflow control plate 255 may be installed to reduce turbulence, and/or to prevent objects from falling into the gap.

Like the airflow control plate 255, the facilities connection locator 203 may be any size and shape, and may occupy all or any portion of the outline of the support apparatus' outline. Both the airflow control plate 255 and facilities connection locator 203 may also be mounted to extend beyond the outline of the support apparatus' frame. Such a facilities connection locator 203 would still provide accurate positioning of facilities lines with respect to the top surface 217 of the equipment support apparatus 201, and such an airflow control plate 255 would still provide airflow management and safety functions.

FIG. 19 is a top isometric view of an exemplary standardized facilities box 301. The exemplary standardized facilities box 301 comprises a bottom surface 303 and a plurality of side walls 305. The standardized facilities box 301 of FIG. 19 therefore provides inherent drop containment and may prevent servicing tools or other components dropped while working in the standardized facilities box 301 from falling to the subfloor. Accordingly, use of the standardized facilities box 301 may increase safety for those working in the subfloor region.

The standardized facilities box 301 comprises mechanisms that allow one or more add-on features to be selectively coupled (i.e., attached at predetermined locations without machining). Such mechanisms may be, for example, conventional mechanisms such as tongues or grooves for coupling to a corresponding tongue or groove of an add-on feature. Snap couplings, threaded couplings, predrilled bolt or screw holes, premachined slots, etc. The specific mechanism employed for selective coupling is not material. Accordingly, in FIG. 19 the coupling mechanisms are generally represented by reference number 307. When a specific one of the exemplary coupling mechanisms is described, an alphabetical reference is added to the general reference number 307.

An individual add-on feature may be selectively coupled to the standardized facilities box 301 if that specific add-on feature is needed for a particular installation. In this manner installation is both facilitated, as on site machining of the facilities box 301 is not required, and standardized, as the specific add-on features are in a known location within the standardized facilities box 301. To the extent there is more than one location within a given standardized facilities box 301 for a given add-on feature, it follows that the location for the add-on feature may be further specified. Standardization of facilities connections simplifies troubleshooting, enables use of standardized documentation such as installation, maintenance or safety information. Moreover, standardization of facilities connection locations (e.g., process gas or fluid lines, vacuum or exhaust lines) from one installation to the next, promotes greater processing uniformity. In one aspect, the specific add-on features may be positioned (e.g., moved around adjacent various coupling mechanisms, until a desired fit (for example, allowing the desired number of add on features) is achieved.

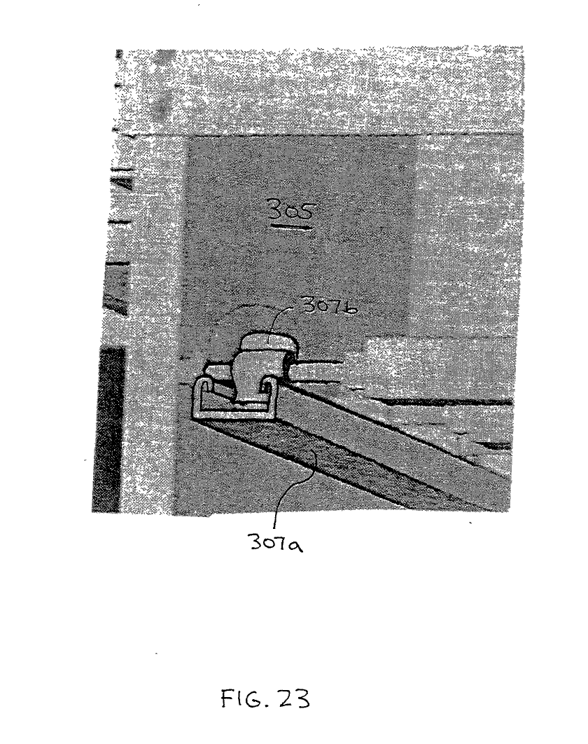

Coupling mechanisms 307 of an exemplary standardized facilities box 301 may include, for example, a guide (e.g., a grooved track or rail) 307a which may run along the interior and/or exterior of the bottom surface 303 and/or along the interior or exterior of the one or more side walls 305. One or more locating mechanisms 307b (such as snap couplings, bolt/screw holes, or mechanical stops, etc.) may be positioned along the guide 307a as shown on the bottom wall 305 of FIG. 19. FIG. 23 is a close up perspective view, taken from the side, showing an exemplary locating mechanism 307b (such as a tubing clamp) coupled in a tongue and groove manner to a unistrut rail type coupling mechanism 307a Alternatively, the guide 307a may be omitted, and only the locating mechanisms 307b (bolt holes, or threaded holes, etc.) employed, as shown on the sidewall 305 of FIG. 19.

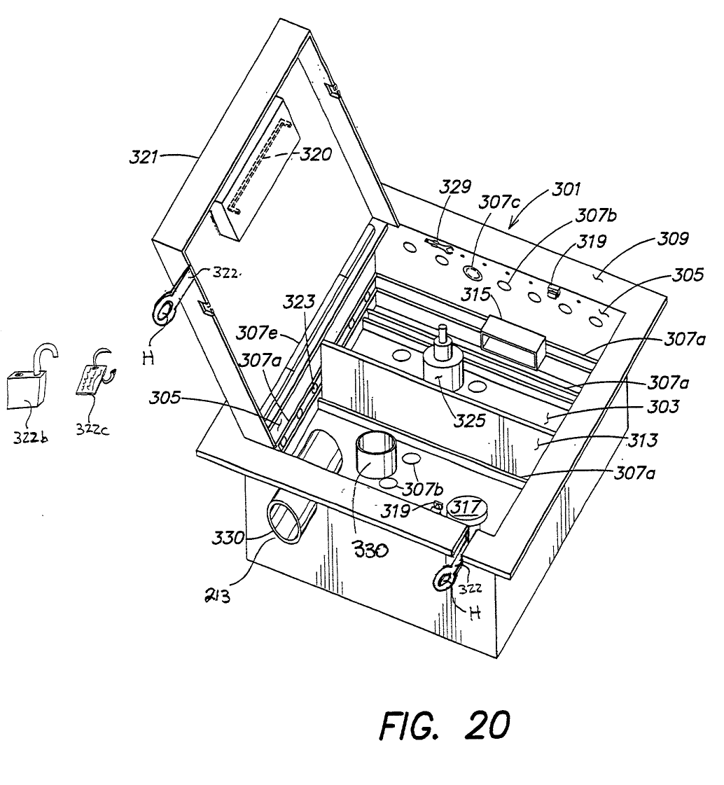

Other coupling mechanisms 307 may comprise one or more precut openings, or perforated knockouts (e.g., portions of the sidewalls or bottom of the facilities box that may be easily removed with manual force, such as when struck by a hammer or mallet), through which facilities connections may be made (e.g., through which a subfloor facilities line may be coupled to a processing tool located above the raised floor). The precut openings may include a removable cap 307c (FIG. 20) which may snap or screw in place, for example. The precut openings of perforated knockouts may include snap, twist or screw on mechanisms to which a riser 213 (such as that described with reference to FIG. 11) or other z-axis locating mechanism may be selectively coupled. The top of the side walls 305 may include a coupling mechanism for coupling a cover to the standardized facilities box 301 (e.g., a hinge 307e (FIG. 20)), a prefacilitated location for mounting a hinge, snap fit mechanisms or tabs).

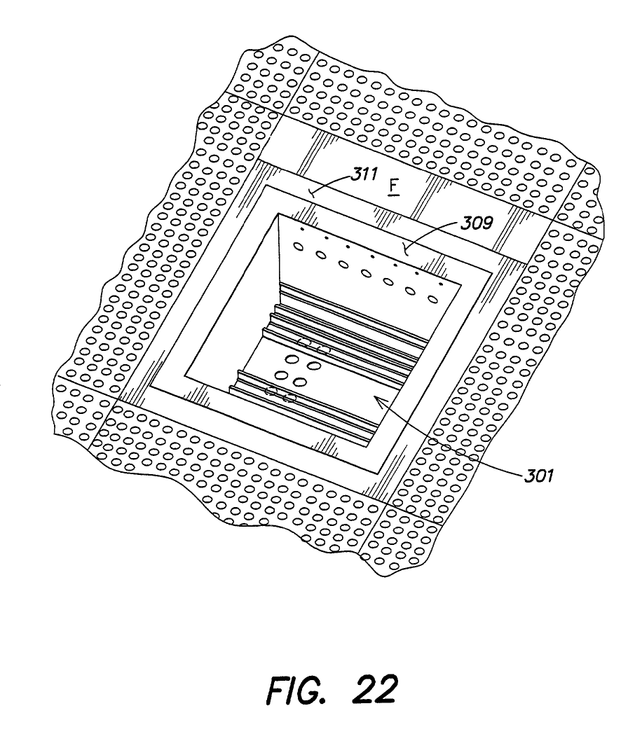

The exemplary standardized facilities box 301 also may comprise a flange 309 for coupling the standardized facilities box 301 to the raised floor 168 (FIG. 8), to a support pedestal 140 (FIG. 8) or to a bridge flange 311 (shown in FIG. 22). The flange 309 may include a coupling mechanism 307 for coupling the flange 309 to any one of a number of bridge flanges 311 (FIG. 22). In one aspect the flange 309 and the bridge flange 311 may couple, simply by overlapping such that the bridge flange 311 supports the flange 309. Each of the bridge flanges 311 may be adapted to couple to a floor tile, tool pedestal, etc., of differing thickness. Further each bridge flange 311 may be of varying size so as to fill open space (resulting from floor tile removal) that is not occupied by the standardized facilities box 301. Alternatively, a filler plate F (FIG. 22) may be provided to occupy such open space. Standard sizes of filler plates F may be provided for use with commonly used raised floor systems. The filler plate F may be perforated so as not to interfere with laminar air flow, and will be strong enough to support operator traffic. It will be understood that any selectively coupleable member that adapts a standardized facilities box to a floor tile grid system that employs floor tiles having a larger footprint then the footprint of the standardized facilities box (e.g., larger than the footprint of the flange 309), may be considered a bridge mechanism. In this manner, floor tile cutting may be avoided, and standardized facilities box 301 installation further facilitated.

FIG. 20 shows the standardized facilities box 301 of FIG. 19 having a plurality of add-on features coupled thereto. It should be emphasized that the positions of the add-on features are merely exemplary, as the standardized facilities box 301 may allow a number of predefined positions for a given add-on feature.

As shown in FIG. 20, a partition 313 is shown coupled to the guide 307a that runs along the bottom surface 303, and may function to separate incompatible facilities (e.g., fluids and electrical lines). A document storage compartment 315 is shown coupled to the guide 307a that runs along one of the side walls 305. As with each of the add-on features, the document storage compartment 315 may be coupled to a coupling mechanism 307 at any location. A particularly advantageous location may be to locate the document storage compartment 315 on the underside of the cover 321.

A sensor 317 (e.g., a heat, fluid, or pressure sensor) is shown coupled to the locating mechanisms 307b. The sensor 317 may include a warning indicator such as a visual (e.g., a flag that ejects from a cylinder and is visible through the transparent cover 321) or audible warning indicator. A lockout mechanism 319 may operatively couple to the sensor 317 and may function for example to lock a cover 321 (shown hingedly coupled to the standardized facilities box 301) when a given condition (fire, leak, etc.) is detected by the sensor 317 or is detected elsewhere in the semiconductor fabrication facility. Also, any individual facilities connection line within the facilities box 301 may be locked and tagged, as is conventionally known.

Every connection within the box may be locked and tagged out simultaneously via a lock out tag out mechanism 322 fixed to the cover 321 and adapted to allow the cover to be locked and tagged. Conventionally, tagging out means to attach an indicator that identifies for example, which operator has locked the device. Typically the indicators are in the form of a tag, thus the term “tag out” is conventionally employed. Such a mechanism may comprise for example, a pair of sidewardly extending tabs, one that extends from the cover 321, and one that extends from the side of the standardized facilities box 301. Each tab may have a hole H formed therethrough. The two holes H may be adapted such that a lock 322b (e.g., pad lock or combination lock, etc.) and tag 322c can be inserted therethrough, thus locking the cover 321 to the facilities box 301.

Alternatively, the box may include an internal cover (not shown) that need not be adapted to support the weight of personnel or equipment. The internal cover may include a tab that extends upwardly and has a hole that aligns with a hole on a tab internal to the facilities box, thus allowing the internal cover to be locked to the facilities box. Thereafter, the cover 321, may be closed over the internal cover, if desired. As will be apparent, a lockout mechanism may take a number of different forms, and may be located at a number of different positions. Accordingly, the lock out mechanism shown and described herein is merely exemplary.

The cover 321 may have a recessed and/or retractable handle 320 (FIG. 20) to facilitate lifting. Provided the cover 321 is transparent, a floor lighting strip 323 may be coupled to the standardized facilities box 301 via one of the guides 307a that extend along a side wall 305 of the standardized facilities box 301. The floor lighting strip 323 may be coupled to the sensor 317, and may be adapted to illuminate when a leak, or other malfunction is detected by the sensor 317. Alternatively the floor lighting strip 323 may be coupled to a central monitor, and may be illuminated as floor lighting in the event the lights in the FAB are inoperable. Similarly a lifting mechanism 325 (see FIG. 20) such as a pneumatic lift may be coupled to the standardized facilities box 301 for example via locating mechanisms 307b located on bottom surface 303 of the standardized facilities box 301, and may be adapted to lift/lower items to or from the standardized facilities box 301. Such items may include the cover 321.

In the example of FIG. 20, a pair of tool mounting mechanisms 329 such as snap connectors are shown mounting a service tool (e.g., a wrench). In other embodiments a tool storage mechanism such as an enclosure may be mounted within the standardized facilities box 301. An exhaust mechanism 330 may be coupled (e.g., to a knockout panel 247 (FIG. 12) located on the bottom 303 or the side wall 305) and may be adapted to maintain the internal region of the facilities box 301 at a negative pressure (e.g., coupled to a pump), so as to prevent gas leaks from escaping the box 301. Facilities connections are preferably made in the region internal to the facilities box 301, such that leaks (gas, fluid, etc.) may be contained therein.

FIG. 21 is a side elevational view showing a pair of the standardized facilities boxes 301 of FIG. 19 coupled together or merely placed side by side. In this embodiment the standardized facilities boxes 301 may be coupled via coupling mechanisms (such as a joiner plate (not shown), or an interlocking coupling (not shown)) located on their respective flanges 309. Such interlocking couplings would preferably join in an over/under relationship, so as to maintain planarity with the surrounding floor. Alternatively the standardized facilities boxes 301 may be coupled via coupling mechanisms 307 that are positioned along the sidewalls 305 of the respective standardized facilities boxes 301 or via a bridge flange 311.

Also shown in FIG. 21 are support legs 331a-b, coupled to the standardized facilities boxes 301 via the guide 307a that extends along the exterior of the bottom surface 303. The first support leg 331a is shown extending to the waffle grid subfloor 125 (FIG. 6), and the second support leg 331b is shown cantilevered to a support leg 333 which may be a support leg of the raised floor grid 139 or of a support pedestal 140 for a fabrication tool 111. It will be understood that the support legs 331a-b are optional. Any number of support legs may be employed, and either cantilevered or direct floor coupling supports legs may be employed exclusively. Although, for clarity, the flanges 309 of the standardized facilities boxes 301 are shown resting on top of the raised floor 139, in a preferred aspect, the flanges 309's of the standardized facilities boxes 301 will be flush with the raised floor or equipment support pedestal to which they are mounted. Note that reference number 340 represents a floor beam of a raised floor, or a beam of an equipment support pedestal.

Installation of one or more new tools for semiconductor device fabrication may be easier and more repeatable from one installation to the next, with use of the inventive system which provides standardized locations for facilities connections, and/or prefacilitated locations for inclusion of add-on features. An exemplary method for using the inventive system to achieve standardization may include indicating a location within a fabrication facility for installing a facilities box; providing a standardized facilities box; providing a plurality of add-on features and specifying which add-on feature should be selectively coupled to which selective coupling mechanism of the standardized facilities box.

Although the inventive system of standardized facilities boxes and add-on features is most advantageous for locating and standardizing facilities connections to a processing tool, in other aspects, the standardized facilities box may be used for locating joints in a length of a fluid, gas or electrical line which may extend along a factory for producing semiconductor devices (i.e., a FAB). By locating such joints with a facilities box, areas where maintenance or further connections are most likely to be needed are easy to identify and access. Further, inherent drop and/or leak containment may be provided by the standardized facilities box. The facilities boxes may be fluid tight and/or may be maintained at a negative pressure via coupling to a facilities exhaust line.

In other aspects the facilities location box may merely provide a convenient location for containing needed tools, documents, safety indicators, floor lights, etc. Accordingly, in a further aspect, the invention comprises a FAB that employs facilities boxes in such a manner. Another aspect comprises a method for standardized FAB construction, that provides specific locations for standardized facilities boxes, and specific add-on features to be included therein. Finally, it should be understood that many of the add-on features may themselves be inventive when used within a facilities box. Accordingly, the invention may comprise a facilities box with such features, whether or not the add-on feature is fixedly or selectively coupled to the box. Examples may include a facilities box that comprises a support leg of its own, thus allowing the facilities box to be coupled directly to a raised floor (as shown in FIG. 21), rather than to an equipment pedestal. Further examples may include a facilities box that comprises lift/lowering mechanisms, and/or a facilities box that includes sensors, an exhaust mechanism, or a lockout mechanism (i.e., a mechanism adapted to automatically lock a cover of the facilities box when a specific condition is sensed).

The foregoing description discloses only a preferred embodiment of the invention; modifications of the above disclosed apparatus which fall within the scope of the invention will be readily apparent to those of ordinary skill in the art. For instance, in another aspect of the invention, the standardized facilities box may include a mechanism for mounting the box in a wall, ceiling, or other surface, instead of to a pedestal or a tile of a raised floor. Such embodiments also may advantageously employ any of the add-on features listed herein. Add-on features such as a coupling to an exhaust mechanism (e.g., plant wide exhaust), sensors, lockout mechanisms, fluid containment, a coupling mechanism for coupling the facilities box to a drain line or fluid pump, are of particular advantage.

While the standardized facilities box is advantageously used adjacent a piece of manufacturing equipment, the standardized facilities box may also be employed at other locations within the FAB. In one aspect, the standardized facilities box may provide leak containment at any location where pipes are joined. In a further aspect, the standardized facilities box itself may be assembled by the end user. That is, standard sizes of side walls 307 and bottom walls 305 may be provided for assembly by the end user. such standardized walls may contain integral joining features (e.g., tongue and groove couplings, predrilled holes for bolts or screws, etc.) and/or joining members (e.g., corner pieces with rails, tongue and groove coupling components, bolt or screw holes) may be provided. Accordingly, while the present invention has been disclosed in connection with exemplary embodiments thereof, it should be understood that other embodiments may fall within the spirit and scope of the invention, as defined by the following claims.

The invention claimed is:

1. A standardized facilities box comprising:
a box;
a mechanism for mounting the box to a support pedestal of a semiconductor fabrication facility; and
one or more mechanisms for selectively coupling any one of a set of add-on features within the box.

2. The standardized facilities box of claim 1 further comprising an add-on feature coupled to the one or more mechanisms for selectively coupling.

3. The standardized facilities box of claim 2 wherein the add-on feature comprises a partition.

4. The standardized facilities box of claim 2 wherein the add-on feature comprises a document storage compartment.

5. The standardized facilities box of claim 2 wherein the add-on feature comprises a sensor and a warning indicator.

6. The standardized facilities box of claim 2 wherein the add-on feature comprises an automatic lockout mechanism.

7. The standardized facilities box of claim 2 wherein the add-on feature comprises a tool storage mechanism.

8. The standardized facilities box of claim 2 wherein the add-on feature comprises a support leg.

9. The standardized facilities box of claim 2 wherein the add-on feature comprises a bridge mechanism adapted to interface between the mechanism for mounting the box and a support pedestal.

10. The standardized facilities box of claim 2 wherein the add-on feature comprises a mechanical locating mechanism for a facilities connection.

11. The standardized facilities box of claim 2 wherein the add-on feature comprises another standardized facilities box comprising:
a box;
a mechanism for mounting the box to a support pedestal of a semiconductor fabrication facility; and
one or more mechanisms for selectively coupling any one of a set of add-on features to the box.

12. The standardized facilities box of claim 2 wherein the add-on feature comprises an openable cover.

13. The standardized facilities box of claim 2 wherein the add-on feature comprises floor lighting.

14. The standardized facilities box of claim 2 wherein the add-on feature comprises a lifting mechanism adapted to lift and/or lower the box into or from a position for mounting the box to a support pedestal.

15. The standardized facilities box of claim 2 wherein the add-on feature comprises a lifting mechanism adapted to lift and/or lower an item to or from the box.

16. A facilities box comprising:
a box;
a mechanism for mounting the box to a raised floor tile of a semiconductor fabrication facility; and
a support leg coupled to the box for supporting the box.

17. A facilities box comprising:
a box adapted to house facilities connections therein;
a mechanism for mounting the box to a support pedestal of a semiconductor fabrication facility; and
a lifting mechanism coupled to the box adapted to lift and/or lower the box into or from a position for mounting the box to a support pedestal.

18. A facilities box comprising:
a box adapted to house facilities connections therein;
a mechanism for mounting the box to a support pedestal of a semiconductor fabrication facility; and
a lifting mechanism adapted to lift and/or lower an item to or from the box.

19. A facilities box comprising:
a box adapted to house facilities connections therein;
a mechanism for mounting the box to a support pedestal of a semiconductor fabrication facility; and
a sensor.

20. A facilities box comprising:
a box adapted to house facilities connections therein;
a mechanism for mounting the box to a support pedestal of a semiconductor fabrication facility; and
an exhaust mechanism.

21. A facilities box comprising:
a box adapted to house facilities connections therein;
a mechanism for mounting the box to a support pedestal of a semiconductor fabrication facility;
a cover coupled to the box; and
a lockout mechanism adapted to lock the cover of the box.

22. The facilities box of claim 21 wherein the lockout mechanism is a lockout tag out mechanism.

23. A method of standardizing a semiconductor fabrication facility, comprising:
indicating a location within a fabrication facility for installing a facilities box;
providing a standardized facilities box having a mechanism for selectively coupling any one of a set of add-on features to the standardized facilities box;
providing a plurality of add-on features; and
specifying which add-on feature should be selectively coupled to which selective coupling mechanism of the standardized facilities box.
